(19) United States
(12) Patent Application Publication
(10) Pub. No.: US 2011/0177433 A1
(43) Pub. Date: Jul. 21, 2011

(54) ANODE FOR A MOLTEN CARBONATE FUEL CELL AND METHOD FOR THE PRODUCTION THEREOF

(75) Inventors: Marc Bednarz, Bundesland (DE); Juergen Haug, Bundesland (DE); Birgit Hilke, Bundesland (DE); Christoph Riether, Bundesland (DE)

(73) Assignee: MTU Onsite Energy GmbH, Ottobrunn (DE)

(21) Appl. No.: 13/057,682

(22) PCT Filed: Jul. 29, 2009
(86) PCT No.: PCT/EP2009/005476

§ 371 Date: Apr. 12, 2011

(30) Foreign Application Priority Data
Aug. 4, 2008 (DE) 10 2008 036 297.2
Sep. 1, 2008 (DE) 10 2008 045 286.6

(51) Int. Cl. H01M 4/90; H01M 4/88; H01M 8/14

(52) U.S. Cl. 429/527; 429/535

(57) ABSTRACT

The disclosure relates to a method for the production of an anode for a molten carbonate fuel cell, wherein a mixture is created, containing at least one base metal and at least one auxiliary agent, and wherein the mixture is applied onto a carrier structure. The disclosure provides that a mixture is used, which contains at least one auxiliary agent in the form of a metal oxide and/or metal hydroxide, and which contains at least one alkali metal compound. The disclosure further relates to an anode that can be produced according to said method.

The present invention relates to an anode for a molten carbonate fuel cell, with a carrier structure and a mixture which is applied onto the carrier structure, said mixture containing at least one base metal and at least one auxiliary agent in the form of a metal oxide and/or metal hydroxide. The present invention further relates to a method to produce such an anode.

Fuel cells are primary elements in which a chemical reaction between a gas and an electrolyte takes place. In principle, during the process of reversing the electrolysis of water, a fuel gas containing hydrogen is brought to an anode and a cathode gas containing oxygen is brought to a cathode for conversion into water. The energy released in the process is extracted in the form of electrical energy.

Molten carbonate fuel cells (MCFC) are described, for example, in DE 43 03 136 C1 and DE 195 15 457 C1. In their electrochemically active section, they contain an anode, an electrolyte matrix and a cathode. A molten mass of one or more alkali metal carbonates, absorbed in a fine porous electrolyte matrix, serves as the electrolyte. The electrolyte separates the anode from the cathode and seals the gas half-cells of the anode and cathode against each other. Whilst a molten carbonate fuel cell is operated, the cathode is supplied with a gas mixture containing oxygen and carbon dioxide, usually air and carbon dioxide. The oxygen is reduced and, together with the carbon dioxide, converted into carbon ions which then travel to the electrolyte. The anode is supplied with fuel gas containing hydrogen, where the hydrogen oxidizes and, together with the carbon ions from the molten mass, is converted into water and carbon dioxide. The carbon dioxide is looped back to the cathode.

The oxidization of the fuel and the reduction of the oxygen thus occur separately. The operating temperature is usually between 550° C. and 750° C. MCFC cells thus directly and efficiently transform the chemical energy bound in the fuel into electrical energy.

A conventional anode usually consists of a porous anode material based on nickel. Stabilizing the surface of the porous anode material is of significance for the power density and useful life of the anode. In this relation, DE 29 45 565 C2 provides an anode which essentially consists of nickel, cobalt and mixtures thereof and for stabilizing the surface also contains a group of ancillary materials including chrome, zirconium and aluminum in the form of metal powders, oxides or alkali metal salts and mixtures thereof.

In practice, adding aluminum or aluminum compounds (oxides, aluminides) as well as chrome or chrome compounds has proven to be successful. Most often a mixture of nickel and aluminum or nickel and chrome with different stoichiometric proportions is used, where the nickel clearly makes up the biggest share. Adding aluminum or chrome to the anode material of a MCFC is required if nickel-based electrodes are used. The reason for this is that pure nickel is not wetted by the electrolytes, thus no active reaction centers are formed.

During the operation of the MCFC, the stable modifications of aluminum and chrome are their corresponding oxides, i.e., aluminum and chrome are present in the form of oxides. In the process, the contact with the molten carbonate forms alkali metal salts or lithium aluminate made of aluminum oxide, where the lithium originates from the electrolyte which is consumed in the process. This is a disadvantage as the electrolyte should be present in a quantity which is as constant as possible. In order to avoid this, DE 29 45 565 C2 teaches to add alkali metal compounds to the anode materials and to subject the mixture to a sintering process, i.e., a high temperature treatment under a reduced atmosphere in order to form the alkali metal salts before the anode is built into the fuel cell. This increases the production efforts and costs.

In order to avoid a sintering process, alloy powder and NiAl or NiCr powders are used in the production of the anode material (“green anode”). The particles of such alloy powders possess, due to the production process (water atomization or air atomization from the molten metal), a spherical or spattered form with a wide, non-controllable particle size distribution between 5 μm and 100 μm. The alloy powder must be sieved in order to obtain certain desired particle sizes. As the quantity of the desired small-sized particles is very low due to the production process, it has a significant impact on the price for the alloy powder which can be used.

A disadvantage is that an active pore design (size, shape, number, etc.) is not possible during the production of the anode materials, as the size of the pores is determined by the size of the knuckle created between the powder particles, and said powder particles cannot be made arbitrarily small.

U.S. Pat. No. 5,415,833 presents an alternative production method for MCFC anodes where a mixture of nickel, an alloy metal such as aluminum or chrome, an activator (ammonium chloride or a sodium halogenide) and a filling material are subjected to a high temperature process where a NiAl or a NiCr alloy is formed. Other than the efforts and resulting high costs associated with the high temperature process, said method also has the disadvantage that the active layer of the resulting anode is very sensitive due to the high temperature process and has to be handled with great care.

The task of the present invention thus is to further develop an anode of the above-stated type as well as its production method such that an active pore design is possible and economical, and the loss of electrolytes can be avoided.

The solution consists of a method with the characteristics of patent claim 1 as well as an anode with the characteristics of patent claims 11 and 12. According to the invention, it is intended that a mixture is used which contains pure nickel as the base metal and which contains at least one auxiliary agent in the form of a metal oxide and/or metal hydroxide and which contains at least one alkali metal compound. The invented anode thus has the characteristics that the mixture contains pure nickel as the base metal and contains at least one auxiliary agent in the form of a metal oxide and/or metal hydroxide and contains at least one alkali metal compound.

The object of the present invention further relates to a molten carbonate fuel cell with at least one such anode.

With the invented method, it is possible for the first time to produce a so-called “green anode” which does not contain any alloy powder but which can still be directly built into the MCFC without a prior thermal process (such as, for example, a sintering process) being required. On starting up the MCFC with the cell stack containing the invented anodes, a porous anode is created where the alkali metal compound reacts in situ with the auxiliary agent in the form of a metal oxide and/or metal hydroxide into an alkali metal salt without consuming electrolyte materials. The anode created during the start-up of the MCFC exhibits long-term creep strength and power density comparable to prior art anodes made of alloy powder. The useful life of the invented anode corresponds to that of the prior art anodes as the consumption of electrolyte materials shortens the useful life of the MCFC and adding alkali metal compounds avoids a consumption of electrolytes at the start-up of the MCFC.

In addition, the use of pure nickel powder allows for an active pore design. The particle size distribution of the nickel powder can be set, which allows for a certain desired pore size in the invented anode to be actively achieved. This is of significance because it is desirable for optimal performance of the MCFC to create an approximately equal pore distribution for the anode and cathode. This achieves an even electrolyte distribution between the electrodes, as the electrolyte is kept in the electrodes due to the capillary force. The pore distribution in the standard cathodes usually shows a maximum at 1 μm to 10 μm, preferably at 1 μm to 2 μm. Such a pore distribution in the anodes cannot be achieved by prior art, but can easily be achieved in the invented anodes, in particular if the same nickel powder is used in the production of the invented anode and the corresponding cathode.

Furthermore, the production of nickel powder is a simple and easily controllable process and the yield of the desired particle size distribution is significantly higher than in the production of alloy powders. The nickel powder is thus also significantly more cost effective than the alloy powder.

Adding an auxiliary agent in the form of a metal oxide and/or metal hydroxide in accordance with the invention serves the purpose of achieving a wetting of the invented anode. The metal oxide or metal hydroxide furthermore acts as a sintering inhibitor which prevents the coalescing of the nickel during the operation of the MCFC.

Advantageous further developments arise from the dependent claims.

Suitable auxiliary agents include all metals whose oxides achieve a wetting of the invented anode and which act as a sintering inhibitor. Preferred are aluminum, chrome, iron, man-ganese and magnesium. Aluminum is particularly preferred.

The choice of the alkali metal compound depends on which electrolyte is to be used in the MCFC. Suitable compounds include, for example, lithium carbonate, sodium carbonate and potassium carbonate. Lithium carbonate is particularly preferred.

Preferred for use are nickel powders whose average particle size may be, for example, between 0.5 μm and 15 μm.

The mixture, if used in accordance with the invention, has a preferred mixture ratio ranging from 1 volume part nickel to 0.1 volume parts of auxiliary agents with alkali metal compounds (1.0:0.1) to 1 volume part nickel to 3 volume parts of auxiliary agents with alkali metal compounds (1.0:3.0). A particularly preferred mixture ratio ranges from 1 volume part nickel to 0.2 volume parts of auxiliary agents with alkali metal compounds (1.0:0.2) to 1 volume part nickel to 0.5 volume parts of auxiliary agents with alkali metal compounds (1.0:0.5). Therein the composition of the combination of the auxiliary agents with alkali metal compounds is designed such that the auxiliary agents, together with the alkali metal compound, can completely transform into alkali metal salts.

The mixture used for the production of the invented anode advantageously contains, for the purpose of improving the processability, at least one plasticizer such as, for example, glycerin. The plasticizer may constitute a share of between 1.5% and 5% by weight, preferably between 2% and 3% by weight, in reference to the weight of the mixture without water.

The mixture used for the production of the invented anode may also contain at least one binder such as, for example, a polyvinyl alcohol. The binder may constitute a share of between 15% and 40% by weight, preferably between 20% and 30% by weight, in reference to the weight of the mixture without water.

The nickel used, which generally is in powder form, may be subjected to a prior mechanical treatment (such as grinding or shearing) in order to set a defined particle size distribution.

In addition, the mixture used may contain at least one pore-creating material. Such pore-creating materials are known. Suitable materials include, for example, particles and fibers which burn out with as little residue as possible up to a temperature of around 400° C. A suitable material, for example, is polyethylene. The pore creator may constitute a share of between 0.1% and 8% by weight, preferably between 2% and 3% by weight, in reference to the weight of the mixture without water.

Furthermore, the present invention is not limited to electrodes which are produced from a nickel-slip system. It is also suited, for example, for electrodes which are produced through powder pressing (so-called “dry-doctoring” systems).

An example of the present invention is described in detail below.

The carrier structure or the carrier of the actual electrode is preferably a structure made of a metallic material which is porous or permeable to gas, for example a metal foam or a metallic tissue, preferably made from nickel.

Preferably, nickel powder made by the company Inco (Toronto, Canada), type Ni210 and/or Ni255 and/or Ni287 is used. These nickel powders have a defined particle size distribution such that the active pore design is made easier. In this example, nickel powder with an average particle size of 10 μm is used. Other nickel powders and mixtures of different nickel powders can also be considered.

The auxiliary agent used is a mixture of 40% (by weight) lithium carbonate, 40% (by weight) aluminum hydroxide and 20% (by weight) aluminum oxide. 0.25 volume parts of this mixture were mixed with 1 volume part of nickel powder.

The binder used is 10% Mowiol in H₂O (polyvinyl alcohol of the company Kuraray Europe GmbH, Frankfurt/Main). The chosen plasticizer is glycerin. Agitan 299 of the company Münzing Chemie GmbH, Heilbronn, is used as a defoaming agent.

The basic recipe for the slip of an invented anode is shown in the following table 1.

TABLE 1

| | Actual Value | Actual Value | Dry Weight | Dry Weight |
|---|---|---|---|---|
| | [g] | [% weight] | [g] | [%] |
| Li2CO3 | 50 | 2% | 50 | 3.4 |
| Al(OH)3 | 50 | 2% | 50 | 3.5 |
| Al2O3 | 30 | 1% | 30 | 2.3 |
| Nickel powder | 1,200.00 | 46% | 1,200 | 82.5 |
| Mowiol | 715 | 28% | 71.5 | 4.6 |
| Glycerin | 50 | 2% | 50 | 3.3 |
| Agitan | 5 | 0% | 5 | 0.4 |
| Water | 500 | 19% | 0 | 0.0 |
| Total | 2600 | 100% | 1,456.5 | 100.0 |

The essential characteristics of the resulting slips are:

| | |
|---|---|
| Solids contents (nickel powder) | 82.5% |
| Solids contents (nickel powder + oxides) | 91.7% |
| Water contents | 42.6% |
| Slip density | 1.88 g/cm³ |

The nickel foam and the slip were processed in a generally known manner into the invented (green) anode, which was built into the molten carbonate fuel cell immediately after the drying, i.e., in a green state, where during the first starting up of the fuel cell the anode is completed by the transformation of the at least one auxiliary agent with the at least one alkali metal compound. The completed anode worked impeccably.

1-20. (canceled)

21. A method for producing porous anodes for a molten carbonate fuel cell (MCFC), comprising:
providing pure nickel as a base metal;
adding at least one auxiliary agent to the base metal to form a mixture, the auxiliary agent being a metal oxide or a metal hydroxide,
adding at least one alkali metal-containing compound to the mixture;
applying the mixture to a gas-permeable carrier structure comprising a metal foam or metal tissue thereby forming an anode;
stacking a plurality of MCFCs comprising the formed anodes to form a MCFC stack; and
starting up the MCFC stack thereby causing the alkali metal compound to react with the auxiliary agent to form an alkali metal salt, in situ, without consuming the electrolytic material.

22. The method of claim 21, wherein the metal of the auxiliary agent is selected from the group consisting of comprises aluminum, chromium, iron, manganese, or magnesium.

23. The method of claim 21, wherein the alkali metal-containing compound is selected from the group consisting of lithium-carbonate, sodium-carbonate, or potassium-carbonate.

24. A The method of claim 21, wherein the base metal is pure nickel powder having an average grain size of 0.5 μm to 15 μm.

25. The method of claim 21, wherein the mixture comprises a volume ratio range of from (a) 1:0.1 nickel to auxiliary agents and alkali metal-containing compounds to (b) 1:3 nickel to auxiliary agents and alkali metal-containing compounds.

26. The method of claim 21, wherein the mixture further comprises at least one plasticizer or binder or pore-forming material.

27. The method of claim 21, wherein the pure nickel is a nickel powder that is subjected to a mechanical treatment to achieve a defined particle size distribution.

28. The method of claim 21, wherein the mixture further comprises a solvent and generating a slurry, and after the slurry is applied to the carrier structure, the method further comprising dehydrating the slurry.

29. The method of claim 21, wherein the mixture is solvent-free mixture, the method further comprising compressing the mixture with the carrier structure.

30. An anode for molten carbonate fuel cells (MCFCs), the anode having a carrier structure and a mixture applied to the carrier structure, which mixture comprises at least one base metal and at least one auxiliary agent, wherein the mixture comprises the base metal is nickel powder, the auxiliary agent is in the form of a metal-oxide and/or metal-hydroxide, the mixture further comprising at least one alkali metal-containing compound.

31. The anode of claim 30 wherein the metal of the auxiliary agent comprises aluminum, chromium, iron, manganese, or magnesium.

32. The anode of claim 30 wherein the alkali metal-containing compound is selected from the group consisting of lithium carbonate, sodium carbonate, or potassium carbonate as the alkali metal-containing compound.

33. The anode of claim 30 wherein the base metal comprises pure nickel powder with an average grain size from 0.5 μm to 15 μm.

34. The anode of claim 30 wherein the mixture comprises a volume ratio range of from (a) 1:0.1 nickel to auxiliary agents and alkali metal-containing compounds to (b) 1:3 nickel to auxiliary agents and alkali metal-containing compounds.

35. The anode of claim 30 wherein the mixture further comprises at least one plasticizer, binder or pore forming material.

36. The anode of claim 30 wherein the mixture is on upon the carrier structure in the form of a dehydrated slurry.

37. The anode of claim 30 wherein the mixture is compressed with the carrier structure.
